(19) United States
(12) Patent Application Publication
(10) Pub. No.: US 2016/0105678 A1
(43) Pub. Date: Apr. 14, 2016

(54) Video Parameter Techniques

(71) Applicant: Microsoft Technology Licensing, LLC, Redmond, WA (US)

(72) Inventors: Firoz Dalal, Sammamish, WA (US); Yongjun Wu, Bellevue, WA (US)

(21) Appl. No.: 14/555,358

(22) Filed: Nov. 26, 2014

Related U.S. Application Data
(60) Provisional application No. 62/063,217, filed on Oct. 13, 2014.

(51) Int. Cl. H04N 19/196; H04N 19/136; H04N 19/177; H04N 19/103

(52) U.S. Cl. CPC H04N 19/196; H04N 19/103; H04N 19/136; H04N 19/177

(57) ABSTRACT

Video parameter storage and processing techniques with MPEG-4 file format are described. In one or more implementations, techniques are described in which sequence and parameter sets are specified in-band with collections of pictures of video as the default option. Techniques are also described in which different parameter set identifiers (IDs) are specified for the collections within the video. Techniques are also described in which maximum clip parameters are specified in a sample description box. Further, techniques are described in which parameter sets are inserted at a beginning of sample data when an access unit delimiter (AUD) network access layer (NAL) unit is not present or are inserted after the AUD NAL unit in the video when present.

### PRIORITY APPLICATION

This application claims priority under 35 U.S.C. Section 119(e) as a non-provisional application of U.S. Provisional Application Ser. No. 62/063,217 entitled “Video Parameter Techniques” filed Oct. 13, 2014, the content of which is incorporated by reference herein in its entirety.

### BACKGROUND

Users may consume video in MPEG-4 file format obtained from a variety of different sources utilizing a variety of different device configurations. For example, users may view video in MPEG-4 file format stored locally at a device, streamed from a service provider, and so on. Further, the users may utilize a variety of different devices to view this video, such as mobile computing devices, set-top boxes, portable music devices, traditional desktop personal computers, and so forth.

Convention techniques that are utilized to encode and decode video typically employ out-of-band techniques to include infrequently changing picture parameter information, such as sequence parameters sets (SPSs) and picture parameters sets (PPSs). This information is specified by these conventional techniques at a single time at a beginning of the video, which may then be used to decode the video. Because of this, the video that follows is limited by and thus may not deviate from this information using conventional techniques.

### SUMMARY

Video parameter storage and processing techniques with MPEG-4 file format are described. In one or more implementations, techniques are described in which sequence and picture parameter sets are specified in-band with collections of pictures of video as the default option. Techniques are also described in which different parameter set identifiers (IDs) are specified for the collections within the video. Techniques are also described in which maximum clip parameters are specified in a sample description box. Further, techniques are described in which parameter sets are inserted at a beginning of sample data when an access unit delimiter (AUD) network access layer (NAL) unit is not present or are inserted after the AUD NAL unit in the video when present.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ video parameter techniques.

FIG. 2 depicts a system in an example implementation showing operation of a video processing module of FIG. 1 in greater detail as involving in-band infrequently changing picture parameter information.

FIG. 3 depicts a system in an example implementation showing operation of a video processing module of FIG. 1 in greater detail as utilizing parameter set identifiers.

FIG. 4 depicts a system in an example implementation showing operation of a video processing module of FIG. 1 in greater detail as employing a sample description box.

FIG. 5 is a flow diagram depicting a procedure in an example implementation in which first and second collections of pictures within video are associated with infrequently changing picture parameter information.

FIG. 6 is a flow diagram depicting a procedure in an example implementation in which first and second collections of pictures within video are associated with parameter set identifiers, respectively.

FIG. 7 is a flow diagram depicting a procedure in an example implementation in which a sample description box is encoded and used for decoding that includes a maximum of different values for infrequently changing picture parameter information.

FIG. 8 is a flow diagram depicting a procedure in an example implementation in which parameter sets from a sample description box are inserted into video.

FIG. 9 illustrates an example system including various components of an example device that can be implemented as any type of computing device as described with reference to FIGS. 1-8 to implement embodiments of the techniques described herein.

### DETAILED DESCRIPTION

### Overview

Conventional techniques that are utilized to encode and decode video typically employ out-of-band techniques to include infrequently changing picture parameter information, such as sequence parameters sets (SPSs) and picture parameters sets (PPSs) used by encoding and decoding techniques such as H.264/MPEG-4 AVC or High Efficiency Video Coding (HEVC). Examples of such infrequently changing picture information include picture dimensions, resolutions, profile and level, and so on. Conventional techniques include this information at specified a single time at a beginning of the video, which may then be used to decode the video. Because of this, the video that follows this information is forced to comply with these parameters as deviation may cause the decoding to fail.

Video parameter storage and processing techniques with MPEG-4 file format are described. Encoding of video, such as involved in video recording of H.264 or HEVC in MP4 sink, happens everywhere in modern day life, such as through use of mobile phones, tablets, game consoles, and so on. In the following, compatibility of H.264 or HEVC video recording in MP4 sink, and H.264 or HEV video consumption with MP4 source is addressed, and a set of techniques are described which may be utilized to support compatibility across different devices and platforms for H.264 or HEVC video recording in MP4 sink, and H.264 or HEVC playback with MP4 source.

In one or more implementations, infrequently changing picture parameter information of video, such as sequence parameters sets (SPSs) and picture parameters sets (PPSs) is encoded in-band as part of the video, as the default option. In this way, collections of pictures within the video may have different infrequently changing picture parameter information, and thus support robust video decoding and storage. Additionally, these techniques may also employ different parameter set IDs for each of the collections, which may be used to reduce confusion of parameter set reference and improve robustness on parameter set loss.

Techniques are also described in which when parameter sets are present for a sample description box (STSD), the parameters in the parameters sets represent maximum values across an entirety of a clip of video, which may be utilized for device capability and compatibility verifications. Further, techniques are described in which parameter sets are inserted at a beginning of sample data when an access unit delimiter (AUD) network access layer (NAL) unit is not present or are inserted after the AUD NAL unit in the video when present, which may be used to improve compatibility because if the parameters sets from the sample description box have the same IDs as those in the sample data, those from the sample description box are deprecated and overwritten by the parameter sets in the sample data. Further discussion of these and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

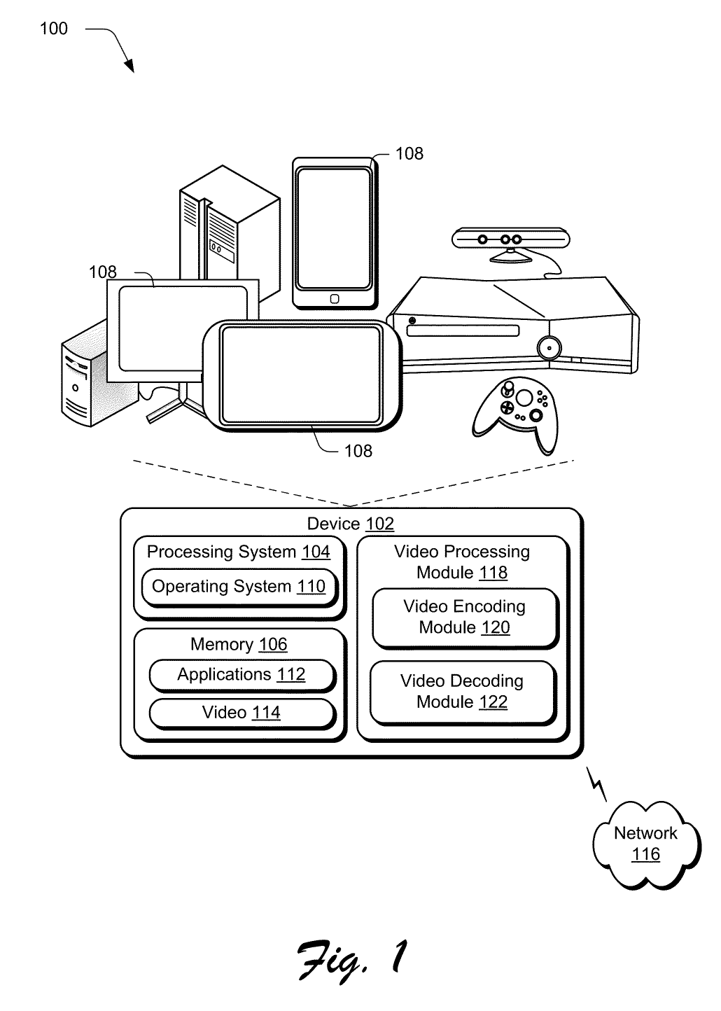

FIG. 1 is an illustration of an environment 100 in an example implementation that is operable to employ the video parameter techniques described herein. The illustrated environment 100 includes a device 102, which may be configured in a variety of ways. For example, the device 102 may be configured as a computing device as illustrated, such as a desktop computer, a mobile station, an entertainment appliance, a mobile computing device having a housing configured in accordance with a handheld configuration (e.g., a mobile phone or tablet), a set-top box communicatively coupled to a display device, a wireless phone, a game console as illustrated, and so forth.

Thus, the device 102 may range from full resource devices with substantial memory and processor resources (e.g., personal computers, game consoles) to a low-resource device with limited memory and/or processing resources (e.g., traditional set-top boxes, hand-held game consoles). Additionally, although a single device 102 is shown, the device 102 may be representative of a plurality of different devices, such as multiple servers utilized by a business to perform operations such as by a web service, a remote control and set-top box combination, an image capture device and a game console configured to capture gestures as illustrated, and so on.

The device 102 is illustrated as including a processing system 104, an example of a computer-readable storage medium illustrated as memory 106, and is configured to provide output to a display device 108, which may or may not be included as integral to the device 102. The processing system 104 is representative of functionality to perform operations through execution of instructions stored in the memory 106. Although illustrated separately, functionality of these components may be further divided, combined (e.g., on an application specific integrated circuit), and so forth without departing from the spirit and scope thereof.

The device 102 is further illustrated as including an operating system 110. The operating system 110 is configured to abstract underlying functionality of the device 102 to applications 112 that are executable on the device 102. For example, the operating system 110 may abstract processing system 104, memory 106, network, and/or display 108 functionality of the computing device 102 such that the applications 112 may be written without knowing “how” this underlying functionality is implemented. The application s 112, for instance, may provide data to the operating system 110 to be decoded, rendered and displayed by the display device 108 without understanding how this rendering will be performed. The operating system 110 may also represent a variety of other functionality, such as to manage a file system and user interface that is navigable by a user of the device 102.

The device 102 is also illustrated as including video 114 that may processed by the video processing module 118, for rendering by the display device 108, encoding for storage, and so on. Although the video 114 is illustrated as stored in memory 106, the video 114 may be obtained from a variety of other sources, such as remotely via a network 116. The video 114 may be encoded according to a variety of different video coding standards to support efficient transfer via the network 116 and/or storage in memory 106. Examples of such video coding standards include H.264/MPEG-4 AVC or High Efficiency Video Coding (HEVC).

The video processing module 118 is illustrated as including a video encoding module 120 and a video decoding module 122 that are representative of functionality, respectively to encode the video 114 (e.g., for storage in memory 106, transmission via the network 116) and decode the video 114, e.g., for rendering by the display device 108. Although illustrated as part of the video processing module 118, it should be readily apparent that functionality represented by the video encoding module 120 and video decoding module 122 may be configured as stand-alone applications, incorporated as part of the operating system 110 and/or one or more applications 112, implemented as part of a web service via a network 116, implemented via hardware (e.g., an application specific integrated circuit), and so forth.

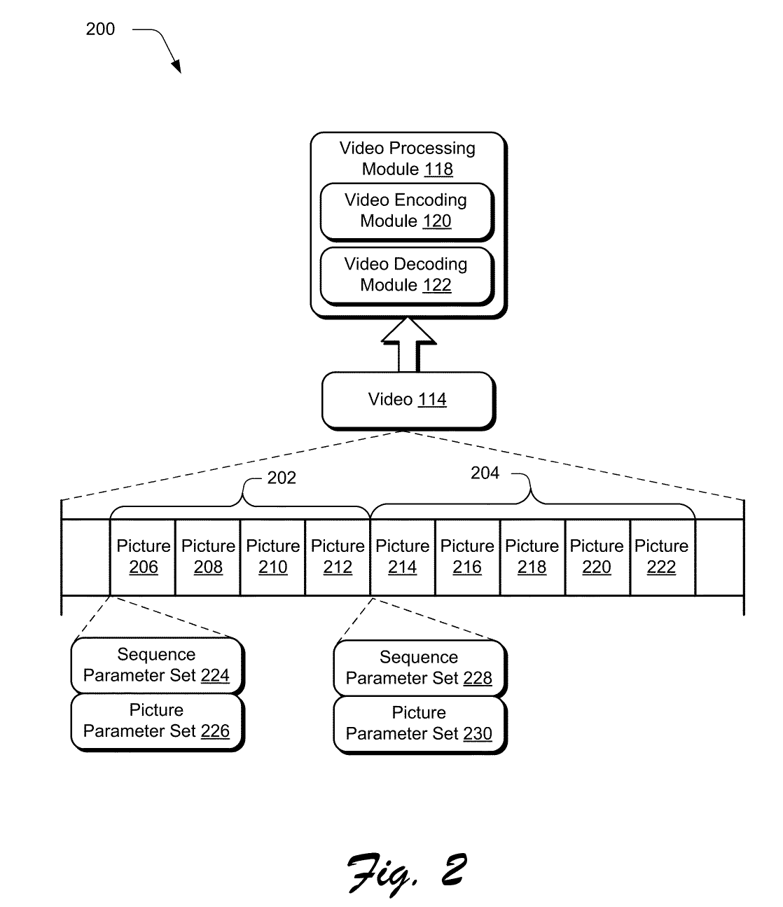

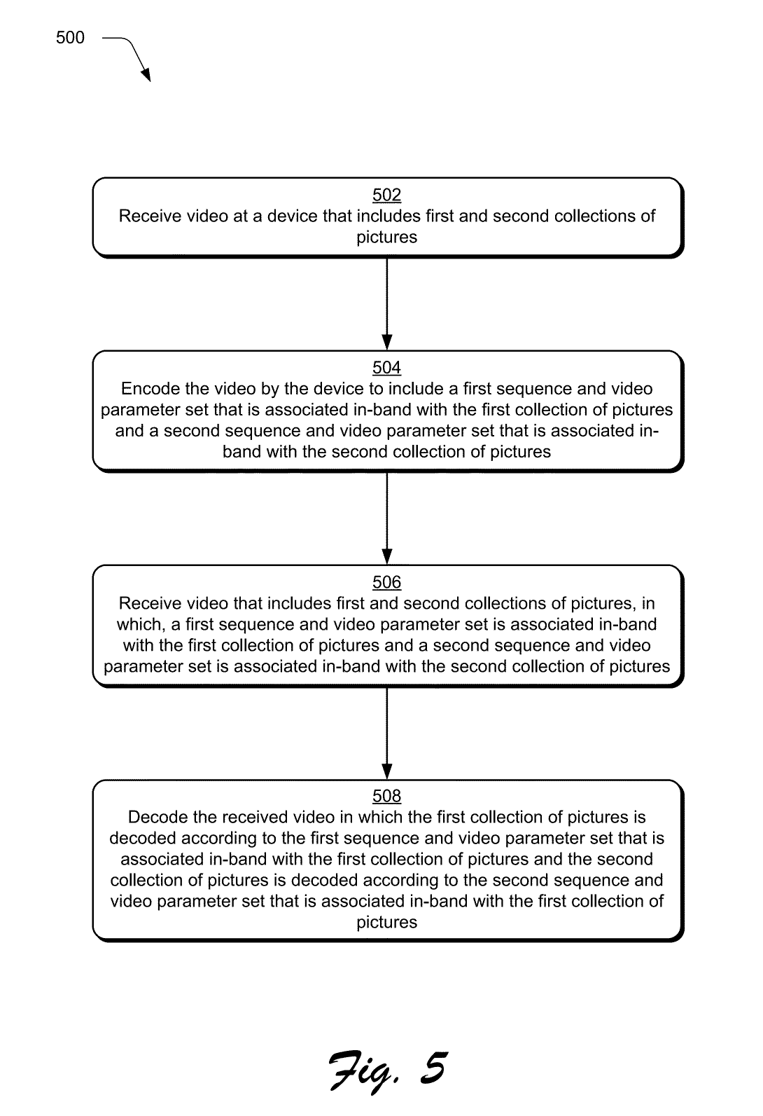

The video processing module 118, and its corresponding video encoding module 120 and video decoding module 122, may employ a variety of video parameter techniques that may improve robustness and efficiency of processing video as described above. For example, the video processing module 118 may be configured to include infrequently changing picture parameter information such as sequence and picture parameter sets included in-band as part of the video 114 for different collections of pictures, further discussion of which may be found in relation to FIGS. 2 and 5.

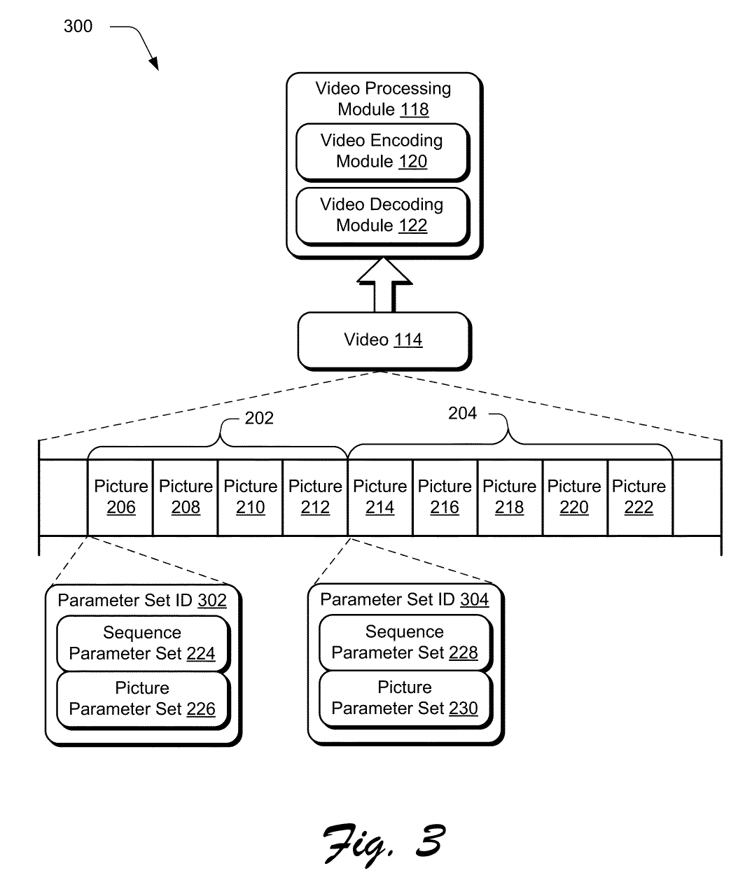

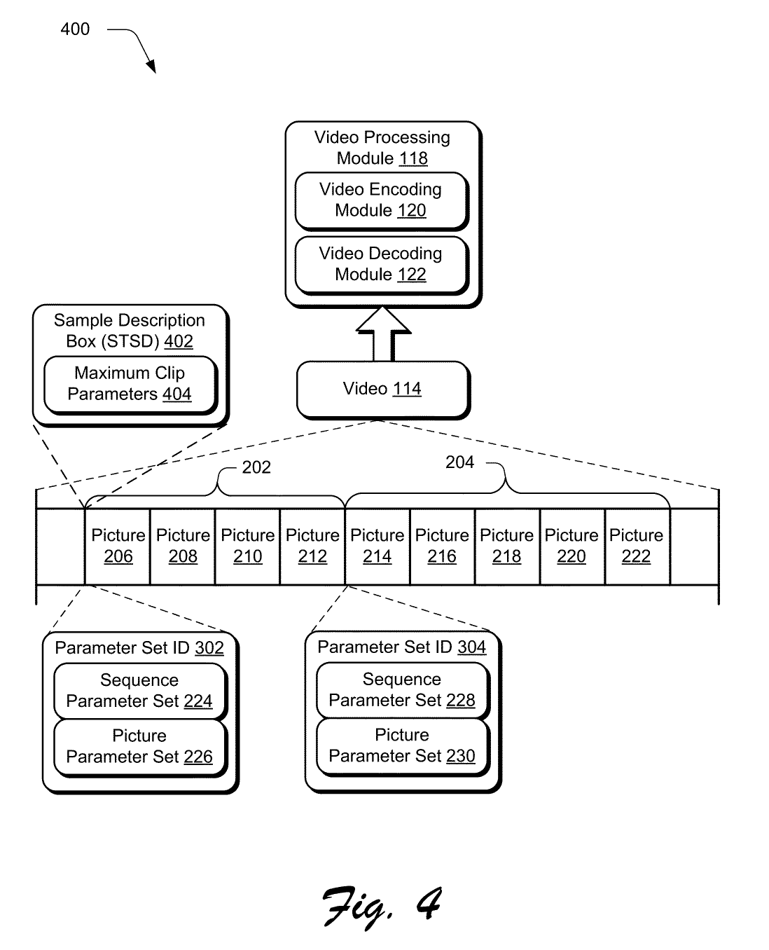

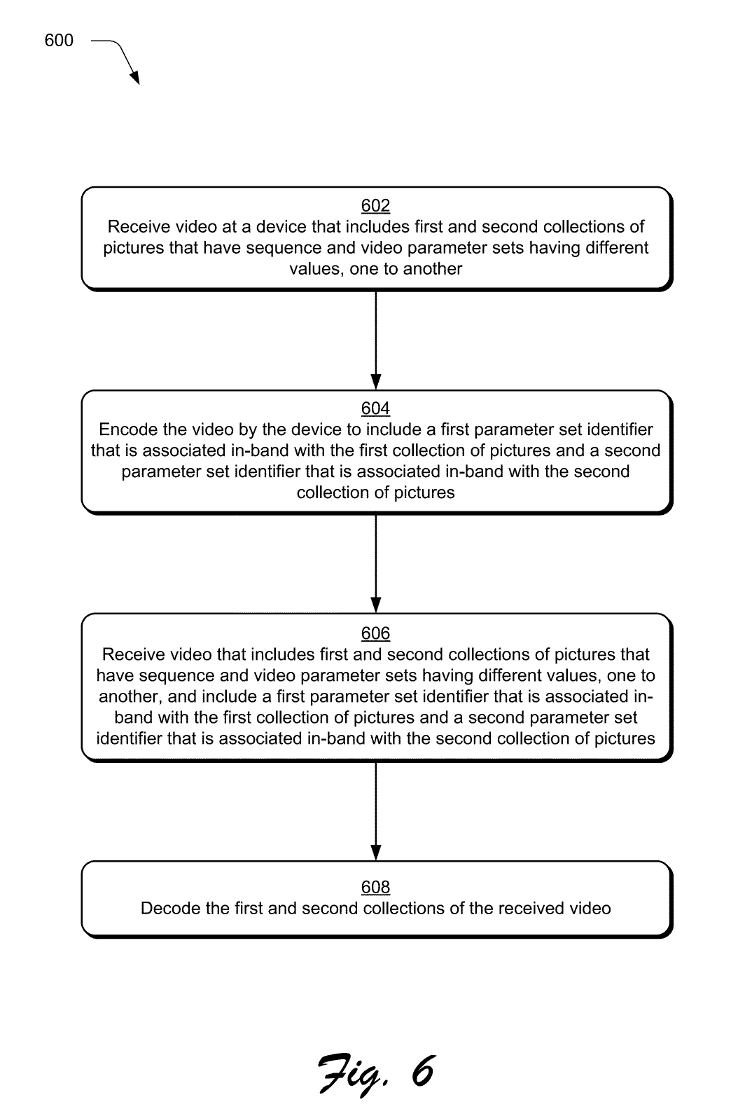

In another example, the video processing module 118 may be configured to include parameter set identifiers (IDs) along with collections of pictures in the video, further discussion of which may be found in relation to FIGS. 3 and 6. In a further example, the video processing module 118 may employ techniques involving a sample description box, such as to include parameters that represent maximum values across an entirety of the video, include insertion techniques involving insertion of parameter sets from the sample description box into the video 114, and so on, further discussion of which may be found in relation to FIGS. 4, 7, and 8.

FIG. 2 depicts a system 200 in an example implementation showing operation of the video processing module 118 in greater detail as involving in-band infrequently changing picture parameter information. As above, although illustrated as part of the video processing module 118, it should be readily apparent that functionality represented by the video encoding module 120 and video decoding module 122 may be configured as stand-alone applications, incorporated as part of the operating system 110 and/or one or more applications 112, implemented as part of a web service via a network 116, implemented via hardware (e.g., an application specific integrated circuit), and so forth.

The video 114 is illustrated as including first and second collections 202, 204 of pictures 206, 208, 210, 212, 214, 216, 218, 220, 222. Examples of pictures 206-222 include frames, fields, and slices, e.g., in accordance with H.264/MPEG-4 AVC, High Efficiency Video Coding (HEVC), and so forth. As previously described, in conventional video encoding and decoding techniques such as H.264/MPEG-4 AVC, High Efficiency Video Coding (HEVC), and so forth, video is limited to a single out-of-band instance of infrequently changing picture parameter information that is used to describe an entirety of the video 114. As such, these conventional techniques do not support inclusion of video having different bit rates, aspect ratios, resolutions, and so forth in a single unit, e.g., “clip.”

The video processing module 118 in this example, however, is configured to include infrequently changing picture parameter information in-band as part of the video 114 and therefore may address differences in collections of pictures included in the video 114. As illustrated, for instance, the video 114 includes a first collection 202 of pictures that includes pictures 206, 208, 210, 212. The video 114 also includes a second collection 204 of pictures that includes pictures 214, 216, 218, 220, 222.

In this example, the first and second collections 202, 204 include characteristics that cause infrequently changing picture parameter information to be different, one from another. This may include different resolutions, bit rates, aspect ratios, and so on. As previously described, this would cause incompatibilities and corresponding failures under conventional techniques. However, in this example, the first and second collections 202, 204 are encoded by the video encoding module 120 to include infrequently changing picture parameter information as associated with the first and second collections 202, 204. In this way, the video decoding module 122 may be apprised of these differences and react accordingly, thereby improving robustness of the system.

The video 114, for instance, includes infrequently changing picture parameter information as a sequence parameter set 224 and a picture parameter set 226. The sequence and picture parameter sets 224, 226 are associated with the first collection 202 in-band within the video 114, as opposed to out-of-band using conventional techniques, e.g., H.264/MPEG-4 AVC, High Efficiency Video Coding (HEVC), and so forth. Likewise, the second collection 204 of the pictures is associated with sequence and picture parameter sets 228, 230 in-band as part of the video 114. Thus, when the video 114 is decoded the video decoding module 122 may leverage these parameters to address changes in characteristics described by the infrequency changing picture parameter information of the pictures and react accordingly, thereby increasing robustness of consumption of the video 114, for storage, rendering, and so forth.

In one or more implementations, on HEVC recording in MP4 sink, in-band parameter set storage with “hev1” is set as the default, which allows video recording with multiple resolution contents, convenient video storage on video editing with different parameter sets in different chunks, file stitching with different resolutions, and so on, instead of “hvc1.” As for H.264 recording, for historical reasons, out-of-band parameter set storage with “avc1” is set as the default, instead of in-band parameter set storage with “avc3” and thus a change may be made to permit in-band parameter set storage as described herein.

FIG. 3 depicts a system 300 in an example implementation showing operation of the video processing module 118 of FIG. 1 in greater detail as utilizing parameter set identifiers. When multiple parameter sets are present on different video collections (e.g., chunks) for in-band parameter set storage, different parameter set IDs 302, 304 are included in-band for different video collections, e.g., the first and second collections 202, 204, unless different video chunks are use the same parameter sets. This may be used to reduce the confusion of parameter set reference and improves the robustness on parameter set loss by the computing device 102.

FIG. 4 depicts a system 400 in an example implementation showing operation of a video processing module 118 of FIG. 1 in greater detail as employing a sample description box 402. MP4 is an extensible container format. The MP4 specification does not define a fixed structure for describing media types in an MP4 container. Instead, it defines an object hierarchy that allows custom structures to be defined for each format. The format description is stored in the sample description (STSD) box 402 for that stream. The sample description box typically contains a list of sample entries. For each sample entry, a 4-byte code defines the format structure.

In the above examples, values for infrequently changing picture parameter information may change for different collections, e.g., the first and second collections 202, 204 may include different resolutions, bit rates, aspect ratios, and so on. Accordingly, in one or more implementations when parameter sets are present for the sample description box 402, the parameters in the parameter sets represent the maximum values across the whole clip as encoded by the video encoding module 120, e.g., a maximum resolution or bit rate. This may be used to support a variety of different functionality, such as for device capability verifications by the video decoding module 122 in order to report whether a given device is able to play the whole clip of video 114, whether transcoding may be employed, and so forth.

When parameter sets from the sample description box 402 are inserted back to the video 114, the parameter sets may be inserted right in the beginning of the sample data when AUD NAL unit is not present, and may be inserted right after AUD NAL unit when present. The access unit delimiter (AUD) indicates an Access Unit Delimiter NAL unit that is a unique NAL unit for identifying a break of the access unit in advanced video coding This practice improves the compatibility because if the parameter sets from the sample description box 402 have the same IDs as those in video 114, those from the sample description box 402 are deprecated and overwritten by the parameter sets in video 114 and thus increases robustness of the system. Further discussion of these and other examples may be found in relation to the following procedures.

### Example Procedures

The following discussion describes video parameter techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

Functionality, features, and concepts described in relation to the examples above may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

FIG. 5 depicts a procedure 500 in an example implementation in which first and second collections of pictures within video are associated with infrequently changing picture parameter information. Video is received at a device that includes first and second collections of pictures (block 502). A video encoding module 120 of the video processing module 118, for instance, may receive video 114.

The video is encoded by the device to include a first sequence and picture parameter set that is associated in-band with the first collection of pictures and a second sequence and picture parameter set that is associated in-band with the second collection of pictures (block 504). Continuing with the previous example, the video encoding module 120 may encode the first and second sequence and picture parameters sets 224, 226, 228, 230 in-band with the video 114 to describe respective collections 202, 204 of the video.

Video is received that includes first and second collections of pictures, in which, a first sequence and picture parameter set is associated in-band with the first collection of pictures and a second sequence and picture parameter set is associated in-band with the second collection of pictures (block 506). In this example, the video may be received by the same device (e.g., from storage) or from another device.

The received video is decoded in which the first collection of pictures is decoded according to the first sequence and picture parameter set that is associated in-band with the first collection of pictures and the second collection of pictures is decoded according to the second sequence and picture parameter set that is associated in-band with the first collection of pictures (block 508).

FIG. 6 depicts a procedure 600 in an example implementation in which first and second collections of pictures within video are associated with parameter set identifiers, respectively. Video is received at a device that includes first and second collections of pictures that have sequence and picture parameter sets having different values, one to another (block 602). A video encoding module 120 of the video processing module 118, for instance, may receive video 114.

The video is encoded by the device to include a first parameter set identifier that is associated in-band with the first collection of pictures and a second parameter set identifier that is associated in-band with the second collection of pictures (block 604). As shown in FIG. 3, for instance, a parameter set ID 302 may be associated with the first collection 202 and a parameter set ID 304 may be associated with the second collection 204 of the video 114.

When multiple parameter sets are present on different video collections for in-band parameter set storage, different parameter set IDs 302, 304 are included in-band for different video collections, e.g., the first and second collections 202, 204, unless different video chunks are really using the same parameter sets. This may be used to reduce the confusion of parameter set reference and improves the robustness on parameter set loss by the computing device 102.

Video is received that includes first and second collections of pictures that have sequence and picture parameter sets having different values, one to another, and include a first parameter set identifier that is associated in-band with the first collection of pictures and a second parameter set identifier that is associated in-band with the second collection of pictures (block 606). In this example, the video may be received by the same device (e.g., from storage) or from another device.

The first and second collections of the received video are decoded (block 608). The video decoding module 122, for instance, may recognize the parameter set IDs 302, 304 as an indication that the infrequently changing picture parameter information has changed. The video decoding module 122 may then example corresponding sequence and picture parameters sets to determine how to decode the pictures of the associated collection of video 114 correctly.

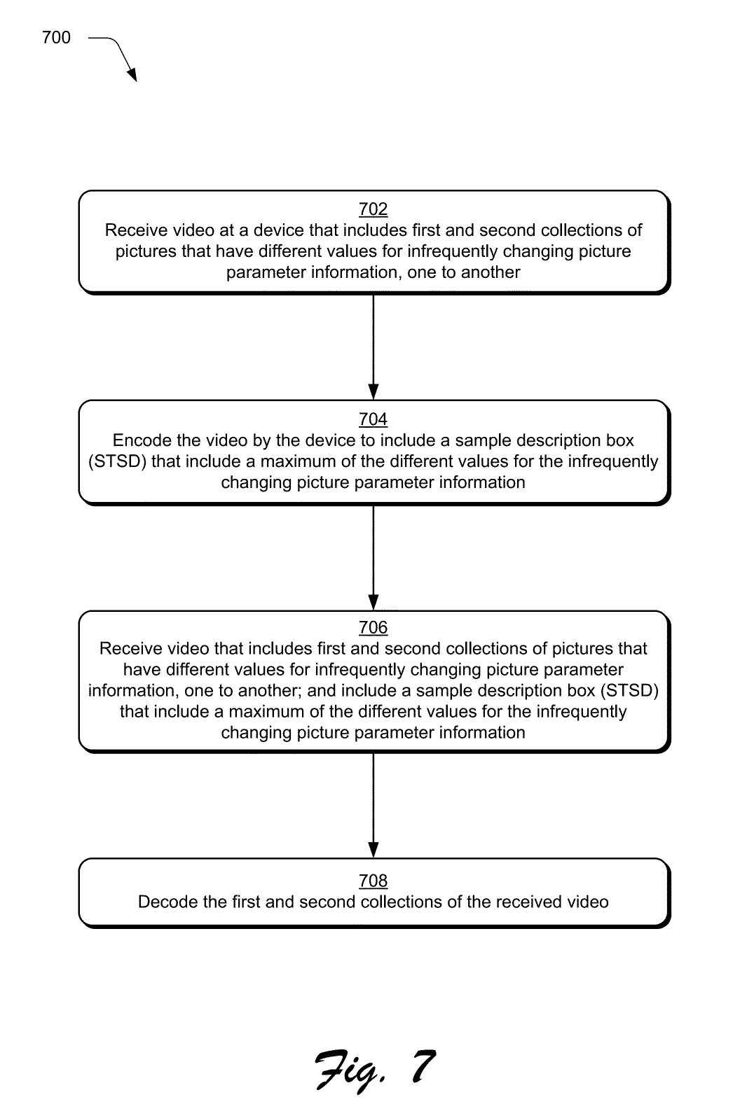

FIG. 7 depicts a procedure 700 in an example implementation in which a sample description box is encoded and used for decoding that includes a maximum of different values for infrequently changing picture parameter information. Video is received at a device that includes first and second collections of pictures that have different values for infrequently changing picture parameter information, one to another (block 702). A video encoding module 120 of the video processing module 118, for instance, may receive video 114.

The video is encoded by the device to include a sample description box (STSD) that include a maximum of the different values for the infrequently changing picture parameter information (block 704). As described above, the MP4 specification does not define a fixed structure for describing media types in an MP4 container. Instead, it defines an object hierarchy that allows custom structures to be defined for each format. The format description is stored in the sample description (STSD) box 402 for that stream. When parameter sets are present for the sample description box 402, the parameters in the parameter sets represent the maximum values across the whole clip as encoded by the video encoding module 120. For example, the first collection 202 of video may encoded as 720p and the second collection 202 of video 204 may be encoded as 1080p. Accordingly, values for resolution in the sample description box 402 may specify a maximum value of 1080p. This may be used to support a variety of different functionality, such as for device capability verifications by the video decoding module 122 in order to report whether a given device is able to play the whole clip of video 114, whether transcoding may be employed, and so forth.

Video is received that includes first and second collections of pictures that have different values for infrequently changing picture parameter information, one to another; and include a sample description box (STSD) that include a maximum of the different values for the infrequently changing picture parameter information (block 706). In this example, the video may be received by the same device (e.g., from storage) or from another device.

The first and second collections of the received video are decoded (block 708). The decoding, for instance, may be performed in response to a determination that the video is compatible based on an examination of the sample description box 402.

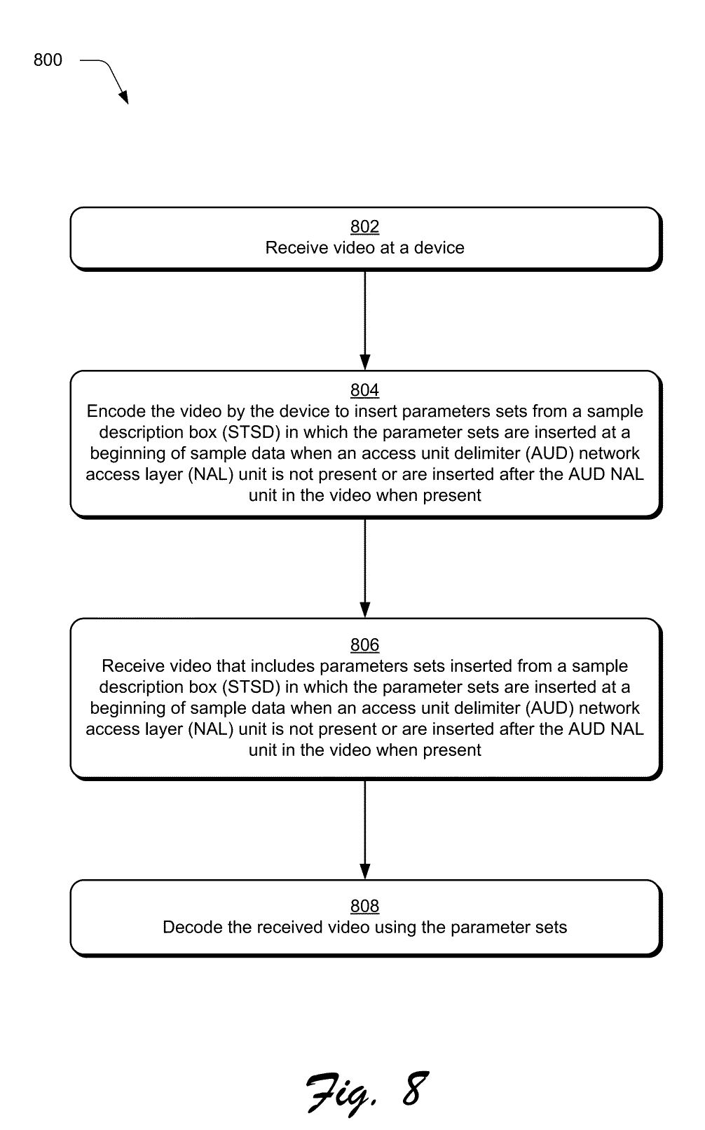

FIG. 8 depicts a procedure 800 in an example implementation in which parameter sets from a sample description box are inserted into video. Video is received at a device (block 802). A video encoding module 120 of the video processing module 118, for instance, may receive video 114.

The video is encoded by the device to insert parameters sets from a sample description box (STSD) in which the parameter sets are inserted at a beginning of sample data when an access unit delimiter (AUD) network access layer (NAL) unit is not present or are inserted after the AUD NAL unit in the video when present (block 804). An AUD indicates an Access Unit Delimiter NAL unit that is a unique NAL unit for identifying a break of an access unit in advanced video coding.

For example, when parameter sets from the sample description box 402 are inserted back to the video 114, the parameter sets may be inserted right in the beginning of the sample data when AUD NAL unit is not present, and may be inserted right after AUD NAL unit when present. This practice improves the compatibility because if the parameter sets from the sample description box 402 have the same IDs as those in video 114, those from the sample description box 402 are deprecated and overwritten by the parameter sets in video 114 and thus increases robustness of the system.

Video is received that includes parameters sets inserted from a sample description box (STSD) in which the parameter sets are inserted at a beginning of sample data when an access unit delimiter (AUD) network access layer (NAL) unit is not present or are inserted after the AUD NAL unit in the video when present (block 806). In this example, the video may be received by the same device (e.g., from storage) or from another device.

The received video is decoded using the parameter sets (block 808). As described above, decoding performed by the video decoding module 122 may have increased robustness in this example because if the parameter sets from the sample description box 402 have the same IDs as those in video 114, those from the sample description box 402 are deprecated and overwritten by the parameter sets in video 114. A variety of other examples are also contemplated.

### Example System and Device

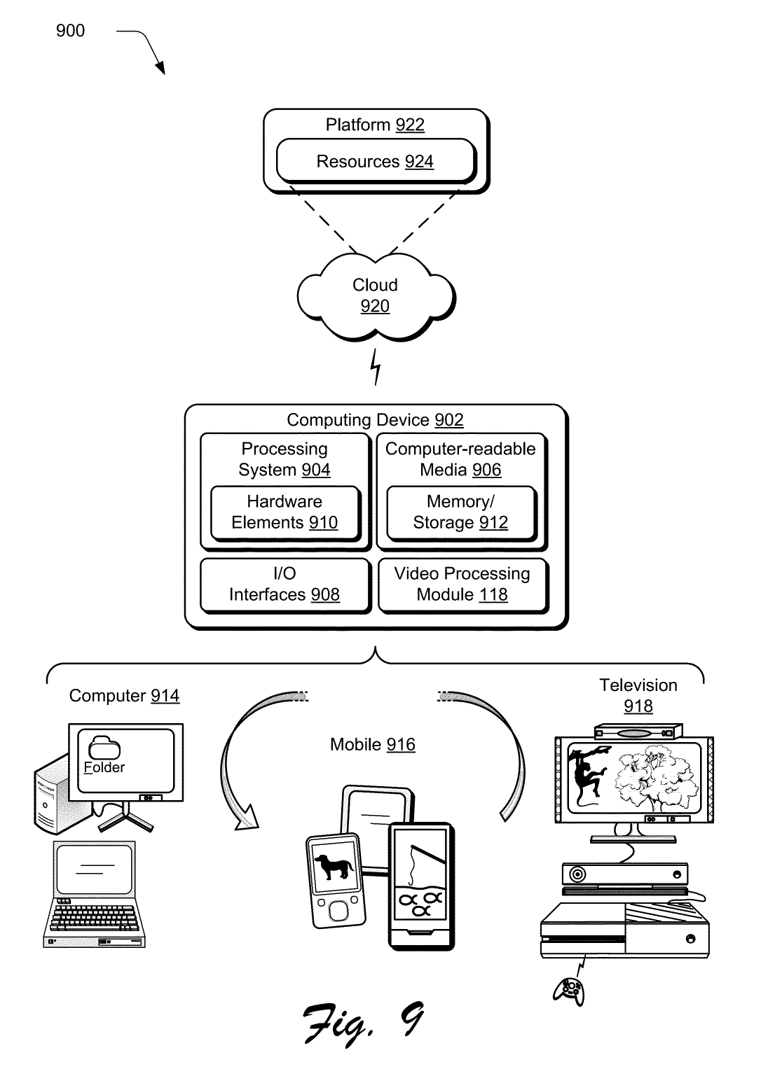

FIG. 9 illustrates an example system generally at 900 that includes an example computing device 902 that is representative of one or more computing systems and/or devices that may implement the various techniques described herein. An example of this is illustrated through inclusion of the video processing module 118. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Explicit Support Section

The follow discussion includes examples of functionality that may be incorporated as methods, computing devices and systems having one or more modules implemented at least partially in hardware, computer readable storage media, and so on. Aspects of these examples may be further combined as multiple dependent features and/or further divided

In an example alone or in combination with the above or below examples, video is received at a device that includes first and second collections of pictures. The video is encoded by the device to include a first sequence and picture parameter set that is associated in-band with the first collection of pictures and a second sequence and picture parameter set that is associated in-band with the second collection of pictures. Video is received that includes first and second collections of pictures, in which, a first sequence and picture parameter set is associated in-band with the first collection of pictures and a second sequence and picture parameter set is associated in-band with the second collection of pictures. The received video is decoded in which the first collection of pictures is decoded according to the first sequence and picture parameter set that is associated in-band with the first collection of pictures and the second collection of pictures is decoded according to the second sequence and picture parameter set that is associated in-band with the first collection of pictures. In one or more examples, the video is configured in accordance with H.264/MPEG-4 AVC. In one or more examples, the video is configured in accordance with High Efficiency Video Coding (HEVC). In one or more examples, the first and second collections include pictures having different encoding or decoding characteristics, one to another. In one or more examples, the first and second collections include pictures having different resolutions, bit rates, or aspect ratios. In one or more examples, the first and second sequence and picture parameters sets describe differences in infrequently changing picture parameter information.

In an example alone or in combination with the above or below examples, video is received at a device that includes first and second collections of pictures that have sequence and picture parameter sets having different values, one to another. The video is encoded by the device to include a first parameter set identifier that is associated in-band with the first collection of pictures and a second parameter set identifier that is associated in-band with the second collection of pictures. Video is received that includes first and second collections of pictures that have sequence and picture parameter sets having different values, one to another, and include a first parameter set identifier that is associated in-band with the first collection of pictures and a second parameter set identifier that is associated in-band with the second collection of pictures. The first and second collections of the received video are decoded. In one or more examples, the video is configured in accordance with H.264/MPEG-4 AVC. In one or more examples, the video is configured in accordance with High Efficiency Video Coding (HEVC). In one or more examples, the first and second collections include pictures having different encoding or decoding characteristics, one to another. In one or more examples, the first and second collections include pictures having different resolutions, bit rates, or aspect ratios. In one or more examples, the first and second sequence and picture parameters sets describe differences in infrequently changing picture parameter information.

In an example alone or in combination with the above or below examples, video is received at a device that includes first and second collections of pictures that have different values for infrequently changing picture parameter information, one to another. The video is encoded by the device to include a sample description box (STSD) that include a maximum of the different values for the infrequently changing picture parameter information. Video is received that includes first and second collections of pictures that have different values for infrequently changing picture parameter information, one to another; and include a sample description box (STSD) that include a maximum of the different values for the infrequently changing picture parameter information. The first and second collections of the received video are decided.

In an example alone or in combination with the above or below examples, video is received at a device. The video is encoded by the device to insert parameters sets from a sample description box (STSD) in which the parameter sets are inserted at a beginning of sample data when an access unit delimiter (AUD) network access layer (NAL) unit is not present or are inserted after the AUD NAL unit in the video when present. An AUD indicates an Access Unit Delimiter NAL unit that is a unique NAL unit for identifying a break of an access unit in advanced video coding. Video is received that includes parameters sets inserted from a sample description box (STSD) in which the parameter sets are inserted at a beginning of sample data when an access unit delimiter (AUD) network access layer (NAL) unit is not present or are inserted after the AUD NAL unit in the video when present. The received video is decoded using the parameter sets.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

1. A method comprising:
receiving video at a device that includes first and second collections of pictures; and
encoding the video by the device to include a first sequence and picture parameter set that is associated in-band with the first collection of pictures and a second sequence and picture parameter set that is associated in-band with the second collection of pictures.

2. A method as described in claim 1, wherein the video is configured in accordance with H.264/MPEG-4 AVC.

3. A method as described in claim 1, wherein the video is configured in accordance with High Efficiency Video Coding (HEVC).

4. A method as described in claim 1, wherein the first and second collections include pictures having different encoding or decoding characteristics, one to another.

5. A method as described in claim 1, wherein the first and second collections include pictures having different resolutions, profiles, levels, or aspect ratios.

6. A method as described in claim 1, wherein the first and second sequence and picture parameters sets describe differences in infrequently changing parameter information.

7. A device comprising:
one or more modules implemented at least partially in hardware, the one or more modules configured to perform operations comprising:
receiving video that includes first and second collections of pictures, in which, a first sequence and picture parameter set is associated in-band with the first collection of pictures and a second sequence and picture parameter set is associated in-band with the second collection of pictures; and
decoding the received video in which the first collection of pictures is decoded according to the first sequence and picture parameter set that is associated in-band with the first collection of pictures and the second collection of pictures is decoded according to the second sequence and picture parameter set that is associated in-band with the first collection of pictures.

8. A device as described in claim 7, wherein the video is configured in accordance with H.264/MPEG-4 AVC.

9. A device as described in claim 7, wherein the video is configured in accordance with High Efficiency Video Coding (HEVC).

10. A device as described in claim 7, wherein the first and second collections include pictures having different encoding or decoding characteristics, one to another.

11. A device as described in claim 7, wherein the first and second collections include pictures having different resolutions, profiles, levels, or aspect ratios.

12. A device as described in claim 7, wherein the first and second sequence and picture parameters sets describe differences in infrequently changing parameter information.

13. A method comprising:
receiving video at a device that includes first and second collections of pictures that have sequence and picture parameter sets having different values, one to another; and
encoding the video by the device to include a first parameter set identifier that is associated in-band with the first collection of pictures and a second parameter set identifier that is associated in-band with the second collection of pictures.

14. A method as described in claim 13, wherein the video is configured in accordance with H.264/MPEG-4 AVC.

15. A method as described in claim 13, wherein the video is configured in accordance with High Efficiency Video Coding (HEVC).

16. A method as described in claim 13, wherein the first and second collections include pictures having different encoding or decoding characteristics, one to another.

17. A method as described in claim 13, wherein the first and second collections include pictures having different resolutions, profiles, levels, or aspect ratios.

18. A method as described in claim 13, wherein the first and second sequence and picture parameters sets describe differences in infrequently changing parameter information.

19-46. (canceled)
